(19) United States
(12) Patent Application Publication
(10) Pub. No.: US 2026/0335055 A1
(43) Pub. Date: Oct. 29, 2026

(54) Material Storage Container For Material For Additively Manufacturing A Dental Restoration, Method For Filling A Material Storage Container And Device And Method For Additively Manufacturing A Dental Restoration

(71) Applicant: Ivoclar Vivadent AG, Schaan (LI)

(72) Inventors: Lorenz Bonderer, Sargans (CH); Steffen Deisinger, Feldkirch (AT); Nector I. Rivera-Torres, Somerset, NJ (US)

(21) Appl. No.: 19/655,811

(22) Filed: Apr. 23, 2026

(30) Foreign Application Priority Data
Apr. 25, 2025 (EP) 25172711.1
Apr. 14, 2026 (EP) 26172400.9

(51) Int. Cl. A61C 13/00; B33Y 40/10

(52) U.S. Cl. CPC A61C 13/0019; B33Y 40/10

(57) ABSTRACT

A storage container for material for additively manufacturing a dental restoration. The storage container includes a receiving space and a supply port that is coupled to the receiving space in a material-conducting manner, in such a way that material can be supplied from the receiving space via the supply port for additively manufacturing the dental restoration. At least a first material and a second material which differ in at least one material characteristic are arranged in the receiving space. The first material and the second material are arranged in succession in a discharge direction of the receiving space; or in a direction transverse to a discharge direction. A method for filling a material storage container, and a device and method for additively manufacturing are included.

### CROSS-REFERENCE TO RELATED APPLICATIONS

This application claims priority to European Patent Application No. 25172711.1 filed on Apr. 25, 2025, and to European Patent Application No. 26172400.9 filed on Apr. 24, 2026, the disclosures of which are incorporated herein by reference in their entirety.

### TECHNICAL FIELD

The invention is directed to a material storage container for material for additively manufacturing a dental restoration. The material storage container comprises a receiving space and a supply port which is coupled to the receiving space in a material-conducting manner, in such a way that material can be supplied from the receiving space via the supply port for additively manufacturing the dental restoration.

The invention also relates to a method for filling a material storage container for material for additively manufacturing a dental restoration.

The invention is also directed to a device for additively manufacturing a dental restoration and to a method for additively manufacturing a dental restoration.

### BACKGROUND

Material storage containers of this type and their use in processes and devices for additively manufacturing dental restorations are known. In this context, another term for additive manufacture is generative or layer-by-layer manufacture. In the course of processes of this type, the dental restoration to be manufactured, or more generally the component to be manufactured, is built up layer by layer on a substrate or on a construction platform. Processes of this type are sometimes also referred to as 3D printing. In particular, replacement teeth, parts of replacement teeth, and partial or full dentures can be manufactured layer by layer using processes and devices of this type. The necessary starting material is supplied using a material storage container, the term cartridge also commonly being used for a material storage container. When dental restorations are manufactured, the highest possible fidelity to the original is always sought, meaning that the dental restoration should be as similar as possible to natural teeth and/or natural gums. However, known devices and processes tend to become more complex as the requirements on the fidelity of the dental restoration to the original become higher.

### SUMMARY

The object of the present invention is to further improve the fidelity of layered dental restorations to the original, in other words to make it possible to manufacture dental restorations with a natural appearance. However, manufacturing the dental restoration should be as simple as possible. In other words, the simplest possible option is to be provided for manufacturing dental restorations which are as close as possible to natural teeth and/or natural gums.

The object is achieved by a material storage container for material for additively manufacturing a dental restoration. The material storage container comprises a receiving space and a supply port which is coupled to the receiving space in a material-conducting manner, in such a way that material can be supplied from the receiving space via the supply port for additively manufacturing the dental restoration. At least a first material and a second material, which differ in at least one material characteristic, are arranged in the receiving space. Furthermore, the first material and the second material are arranged in succession in a discharge direction of the receiving space. Alternatively or additionally, the first material and the second material are arranged in succession in a direction transverse to a discharge direction. A material storage container of this type may therefore be configured in three variants. In a first variant, the first material and the second material are arranged in succession in the discharge direction of the receiving space. In a second variant, the first material and the second material are arranged in succession in a direction transverse to the discharge direction. A third variant relates to a combination of the first variant and the second variant, meaning that materials having different material characteristics are arranged in succession in the discharge direction of the receiving space and also in succession in a direction transverse to the discharge direction. To implement this variant using two materials, the materials may be arranged for example in a chequered pattern. This means that the first material and the second material are arranged in succession in a direction transverse to the discharge direction. In the discharge direction, second material then lies downstream from the first material and first material lies downstream from the second material. It is also possible to implement the third variant using three or more materials, all of the materials differing in at least one material characteristic. In this context, the discharge direction is understood to be a direction in which the material received in the receiving space flows to the supply port when the material storage container is discharged via the supply port, meaning that the material received in the receiving space is used for additively manufacturing a dental restoration. All three variants make it possible to manufacture a dental restoration having high fidelity to the original. This is because in many respects natural teeth and natural gums have properties which vary locally. In this context, a portion of the dental restoration which replicates natural gums may also be referred to as a denture base. This means that these properties may differ from position to position on a natural tooth and on the natural gums. Among other things, this applies to optical properties, in particular colour and translucency, but also to mechanical properties, for example hardness and strength, and chemical properties, in other words the composition of the material from which the natural teeth and natural gums are made. This situation is taken into account by the material storage container according to the invention, which contains at least a first material and a second material which differ in a material characteristic. Thus, at least the first material and the second material can also be used in the dental restorations manufactured using the material storage container according to the invention, and so the locally different properties can also be implemented in the dental restoration. In particular, in this way dental restorations can be manufactured which have a colour gradient from light to dark and/or a transparency gradient from high transparency to low transparency.

Dental restorations which can be manufactured using the material storage container include for example crowns, veneers, bridges, inlays, and onlays. The dental restoration may also be a partial denture which replicates at least one tooth and gum tissue.

Furthermore, the suitability of the material storage container for manufacturing a dental restoration does not exclude the possibility of the material storage container also being suitable for manufacturing components for other applications, in other words for manufacturing sensors or jewellery.

Specifically in the first variant, in other words the variant where the first material and the second material are arranged in succession in the discharge direction, when a dental restoration is manufactured using the material storage container, a portion of the dental restoration may first be manufactured from the one of the first material and second material supplied closer to the delivery port. Subsequently, another portion of the dental restoration may be manufactured from the other material.

This also applies specifically to the second variant, in other words the variant where the first material and the second material are arranged in succession in a direction transverse to the discharge direction. This arrangement implies that the first material and the second material are arranged side by side in the discharge direction. The first material and the second material can therefore be supplied substantially simultaneously via the supply port for manufacturing a dental restoration. The first material and the second material can be mixed after they have left the material storage container. Alternatively, it is also possible to process the first material and the second material unmixed to form a dental restoration. In this variant, it is important to supply the first material and the second material in such a way that the corresponding portions of the dental restoration can be manufactured substantially directly from the materials which differ in at least one material characteristic.

Specifically in the third variant, different materials, in other words at least the first material and the second material, are supplied in the discharge direction, and so portions of a dental restoration can be manufactured sequentially from different materials. In addition, in the third variant, different materials are arranged in succession in a direction transverse to the discharge direction. As mentioned previously, this variant can be implemented using two materials if the materials are arranged for example in a chequered pattern. This means that the first material and the second material are arranged in succession in a direction transverse to the discharge direction. In the discharge direction, second material then lies downstream from the first material and first material lies downstream from the second material. It is also possible to implement the third variant using three or more materials, all of the materials differing in at least one material characteristic. The first material and the second material can therefore always be supplied substantially simultaneously via the supply port for manufacturing a dental restoration. The first material and the second material may be mixed after they have left the material storage container. Alternatively, it is also possible to process the first material and the second material unmixed to form a dental restoration. Since the first material and the second material are also arranged in succession in the discharge direction, different combinations of the first material and the second material, in other words combinations of the first material and the second material which differ for example in the arrangement of the materials, can also be supplied sequentially via the supply port to manufacture a dental restoration.

The at least one material characteristic may describe an optical material property, in particular a material colour and/or a translucency, a mechanical material property or a chemical material property. As mentioned previously, natural teeth and natural gums also have locally different optical properties, mechanical properties and chemical properties. Accordingly, particularly lifelike dental restorations can be manufactured using at least a first material and a second material which differ in material properties of this type. This applies in particular to the colour and translucency, since natural teeth and natural gums each have a colour gradient and a translucency gradient. As regards the mechanical material properties, a dental restoration can be manufactured which has a comparatively hard and strong but brittle surface and a comparatively soft, flexible and tough internal volume.

It will be appreciated that it is of course also possible for the materials in the material storage container to differ in a plurality of material characteristics.

In one variant, the material storage container further comprises a drain port for removing material which is not to be used for additively manufacturing a dental restoration. This configuration opens up the possibility of draining material after it has not been used at all or has only been used in part for manufacturing a portion of a dental restoration. This is advantageous in particular if a subsequent portion of the dental restoration is to be manufactured from a different material. In the event that the material is not to be used at all for manufacturing a dental restoration, a subsequently arranged material is thus made available. This configuration is relevant in particular if at least a first material and a second material are arranged in succession in the receiving space in a discharge direction. Overall, this increases the flexibility of use of the materials contained in the material storage container.

In one embodiment, the first material and the second material may each be arranged in the form of a discrete macroscopic layer. Alternatively or additionally, numerous materials which differ in at least one material characteristic are arranged in the receiving space. The numerous materials are arranged in succession in the discharge direction or transverse to the discharge direction of the receiving space so as to result in a macroscopically continuous progression of the at least one material characteristic. The first material and the second material may therefore be arranged on the one hand in the form of discrete macroscopic layers. This means that the transition from the first material to the second material results in a sudden change in the material characteristic within the material storage container. This also applies to supplying the materials at the supply port for additively manufacturing a dental restoration. Alternatively, numerous materials are present, which comprise the first material and the second material. The numerous materials are arranged in the receiving space so as to result in a macroscopically continuous progression of the at least one material characteristic. This means that there is no sudden change in the material characteristic. With both variants, dental restorations faithful to the original can be manufactured. The variant with the discrete layers is particularly suitable for manufacturing variants in which initially a first portion of the dental restoration is to be manufactured from a first material and subsequently a second portion of the dental restoration is to be manufactured from a second material. The second variant, in other words the variant with a macroscopically continuous progression of the at least one material characteristic, is particularly well suited to manufacturing dental restorations in which a macroscopically continuous progression of the material characteristic is also desired. This also applies in particular to those variants in which the numerous materials are arranged in succession in a direction transverse to the discharge direction, so as to result in the continuous progression of the material characteristic in a direction transverse to the discharge direction.

The material storage container may further comprise a separating element arranged between the first material and the second material to separate the first material from the second material. By means of a separating element of this type, undesirable mixing of the first material and the second material can reliably be prevented. In this way, the quality of a dental restoration manufactured using the material storage container and thus also its fidelity to the original can be further increased. It will be appreciated that, in cases where more than two different materials are arranged in the receiving space of the material storage container, a separating element of this type may be provided between each pair of adjacently arranged materials. Alternatively, it is also possible to provide a separating element only between some adjacently arranged material pairs.

In one embodiment, the separating element and/or a side wall delimiting the receiving space comprise a guide element for guiding the separating element in the discharge direction. The use of a guide element of this type prevents the separating element from moving in an undesirable manner or into undesirable positions, for example from becoming wedged or otherwise losing its separating effect, during discharge of the material storage container, in other words when the materials present in the material storage container are used for manufacturing a dental restoration.

In one example, the guide element is configured as a thickened portion of an edge of the separating element in the discharge direction. This reliably prevents the separating element from tilting relative to the discharge direction.

In another embodiment, the guide contour is formed in a side wall of the receiving space. This reliably prevents undesirable movement of the separating element.

In one example, the separating element may comprise a film or a membrane or a fixed wall element. Separating elements of this type are on the one hand particularly compact, as they can be made comparatively thin, in particular in the discharge direction. At the same time, separating elements of this type can ensure reliable separation of the first material and the second material. For materials that are arranged one behind the other along a direction that runs transversely to the emptying direction, a fixed wall element can ensure simple and reliable separation of the materials.

In one variant, the material storage container may further comprise a perforation element for breaking open the separating element. It will be appreciated that, at the latest in an operating situation where the material located downstream from the separating element in the discharge direction is to be used for manufacturing a dental restoration, an option must be provided for removing this material from the material storage container via the supply port. For this purpose, the separating effect of the separating element must be eliminated, for example by breaking it open. This can be achieved relatively easily and reliably by means of a suitable perforation contour, for example a suitable point or a suitable serrated pattern inside the receiving space.

The object is also achieved by a method for filling a material storage container for material for additively manufacturing a dental restoration. The method comprises introducing a first material and a second material into a receiving space of the material storage container. The first material and the second material differ in at least one material characteristic. Furthermore, the first material and the second material are arranged in succession in a discharge direction of the material storage container. Alternatively or additionally, the first material and the second material are arranged in succession in a direction transverse to a discharge direction. Filling the material storage container therefore comprises three variants. In a first variant, the first material and the second material are arranged in succession in the discharge direction. In a second variant, the first material and the second material are arranged in succession in a direction transverse to the discharge direction. A third variant is a combination of the first variant and the second variant. To implement this variant using two materials, the materials may be arranged for example in a chequered pattern. This means that the first material and the second material are arranged in succession in a direction transverse to the discharge direction. The second material is then arranged downstream from the first material in the discharge direction, and the first material is arranged downstream from the second material. It is also possible to implement the third variant using three or more materials, all of the materials differing in at least one material characteristic. Materials arranged in succession in the discharge direction must necessarily be introduced into the receiving space sequentially. Materials arranged in succession in a direction transverse to the discharge direction may be introduced into the receiving space either simultaneously or sequentially. This makes it possible to create a material storage container which can be used for manufacturing dental restorations faithful to the original, as explained previously. In particular, dental restorations which have a colour gradient from light to dark and/or a transparency gradient from high transparency to low transparency can be manufactured in this way.

Dental restorations which can be manufactured using the material storage container include for example crowns, veneers, bridges, inlays, and onlays. The dental restoration may also be a partial denture which replicates at least one tooth as well as gum tissue.

Furthermore, the suitability of the material storage container for manufacturing a dental restoration does not exclude the possibility that the material storage container may also be suitable for manufacturing components for other applications, for example for manufacturing sensors or jewellery.

In one variant, the method further comprises reducing the viscosity of the first material and/or the second material prior to introduction into the receiving space. A reduced viscosity increases the flowability of the materials and thus facilitates the introduction of the materials into the receiving space. For example, the viscosity may be reduced by heating the materials.

In a variant where at least two materials are introduced into the receiving space sequentially, the viscosity of the material to be introduced into the receiving space may always be reduced, for example by heating it. It may be ensured that the viscosity of a previously introduced material increases again before the subsequent material is introduced. This may be achieved for example by allowing the material which was introduced first to cool down over a particular period of time. It is of course also possible to actively cool the material which was introduced first so as to increase the viscosity again. In this way, precise separation of the materials within the receiving space can be maintained or created, in particular without the use of separating elements.

The object is also achieved by a device for additively manufacturing a dental restoration. The device comprises a construction space for the additive construction of the dental restoration and a material storage container according to the invention which is coupled to the construction space in a material-conducting manner. In particular, the device comprises a drain port for removing material which is not to be used for additively manufacturing a dental restoration. For the material storage container, there are the three variants explained previously. In a first variant, the first material and the second material are arranged in succession in a discharge direction of the receiving space. In a second variant, the first material and the second material are arranged in succession in a direction transverse to a discharge direction. A third variant relates to a combination of the first variant and the second variant, meaning that materials having different material characteristics are arranged in succession in the discharge direction of the receiving space and also in succession in a direction transverse to a discharge direction. To implement this variant using two materials, the materials may for example be arranged in a chequered pattern. This means that the first material and the second material are arranged in succession in a direction transverse to the discharge direction. In the discharge direction, second material then lies downstream from the first material and first material lies downstream from the second material. It is also possible to implement the third variant using three or more materials, all of the materials differing in at least one material characteristic. In this context, the discharge direction is understood to be a direction in which the material received in the receiving space flows to the supply port when the material storage container is discharged via the supply port, meaning that the material received in the receiving space is used for additively manufacturing a dental restoration. All three variants make it possible to manufacture a dental restoration having high fidelity to the original. This is because in many respects natural teeth and natural gums have properties which vary locally. In this context, a portion of the dental restoration which replicates natural gums may also be referred to as a denture base. This means that the properties may differ from position to position on a natural tooth and on natural gums. This applies, among other things, to optical properties, in particular colour and translucency, but also to mechanical properties, for example hardness and strength, and chemical properties, in other words the composition of the material from which the natural teeth and natural gums are made. This situation is taken into account by the material storage container according to the invention and the device according to the invention which comprises it. Thus, at least the first material and the second material can also be used in the dental restorations manufactured using the device according to the invention, and so the locally different properties can also be implemented in the dental restoration. In particular, dental restorations which have a colour gradient from light to dark and/or a transparency gradient from high transparency to low transparency can be manufactured in this way.

Dental restorations which can be manufactured using the device include for example crowns, veneers, bridges, inlays, and onlays. The dental restoration may also be a partial denture which replicates at least one tooth as well as gum tissue.

Furthermore, the suitability of the device for manufacturing a dental restoration does not exclude the possibility that the material storage container may also be suitable for manufacturing components for other applications, for example for manufacturing sensors or jewellery.

As regards the drain port, the device according to the invention comprises two variants. Either the drain port is provided on the material storage container, meaning that the material storage container comprises the drain port. Alternatively, the drain port is provided on the device. In this case, the material storage container may be configured without a drain port. In both variants, material which is not to be used for additively manufacturing a dental restoration can be removed via the drain port. This configuration opens up the possibility of draining material after it has not been used at all or has only been used in part for manufacturing a portion of a dental restoration. This is particularly advantageous if a subsequent portion of the dental restoration is to be manufactured from a different material. In the event that the material is not to be used at all for manufacturing a dental restoration, a subsequently arranged material is thus made available. This configuration is relevant in particular if at least a first material and a second material are arranged in succession in the receiving space in a discharge direction.

The object is also achieved by a method for additively manufacturing a dental restoration. The method comprises:
creating a first component layer of the dental restoration from a first material and subsequently creating a second component layer of the dental restoration from a second material, and/or
creating a component layer from the first material and the second material.

The first material and the second material differ in at least one material characteristic. Furthermore, the first material and the second material are supplied using the same material storage container. In the first alternative of the method, component layers of the dental restoration which are created sequentially are manufactured from materials having at least one different material characteristic. In the second alternative of the method, two materials which differ in at least one material characteristic are used to create the same component layer. This means that a first portion of this component layer is created from the first material and a second portion of the component layer is created from the second material. Using a method of this type, dental restorations having high fidelity to the original can be manufactured. This is because in many respects natural teeth and natural gums have properties which vary locally. In this context, a portion of the dental restoration which replicates natural gums may also be referred to as a denture base. This means that the properties may differ from position to position on a natural tooth and on natural gums. This applies, among other things, to optical properties, in particular colour and translucency, but also to mechanical properties, for example hardness and strength, and chemical properties, in other words the composition of the material from which the natural teeth and natural gums are made. This situation is taken into account by the method, in which at least a first material and a second material which differ in at least one material characteristic are used. In particular, this makes it possible to manufacture dental restorations which have a colour gradient from light to dark and/or a transparency gradient from high transparency to low transparency. Furthermore, the method according to the invention is comparatively simple, since the first material and the second material are supplied using the same material storage container.

In connection with the method according to the invention for additively manufacturing a dental restoration, the dental restoration may for example be a crown, a veneer, a bridge, an inlay, or an onlay. The dental restoration may also be a partial denture which replicates at least one tooth as well as gum tissue.

The method according to the invention may alternatively also be used for manufacturing components for other applications, for example for manufacturing sensors or jewellery.

The method according to the invention for additively manufacturing a dental restoration may be carried out in particular using a material storage container according to the invention. As mentioned previously, the material storage container according to the invention may be configured according to a first variant where the first material and the second material are arranged in succession in a discharge direction of the receiving space. A material storage container of this type is particularly suitable in combination with the first alternative of the method according to the invention for additively manufacturing a dental restoration, in other words the alternative of the method where component layers of the dental restoration which are created sequentially in time are manufactured from materials having at least one different material characteristic. As also mentioned previously, the material storage container according to the invention may be configured according to a second variant. The first material and the second material are then arranged in succession in a direction transverse to a discharge direction. This variant of the material storage container according to the invention is particularly well suited to implementing the second alternative of the method for additively manufacturing the dental restoration, where two materials which differ in at least one material characteristic are used to create the same component layer. The third variant of the material storage container according to the invention, also explained previously, is also particularly well suited to a case where the first alternative of the method for additively manufacturing a dental restoration and the second alternative of the method for manufacturing the dental restoration are combined.

The at least one material characteristic may describe an optical material property, in particular a material colour and/or translucency, a mechanical material property, or a chemical material property. As mentioned previously, natural teeth and natural gums also have locally different optical properties, mechanical properties, and chemical properties. Accordingly, particularly lifelike dental restorations can be manufactured using at least one first material and one second material which differ in material properties of this type. This applies in particular to colour and translucency, since natural teeth and natural gums each have a colour gradient and a translucency gradient.

In one variant, the method further comprises draining first material and/or second material which are not used for manufacturing the dental restoration. Thus, first material and/or second material which are not to be used for additively manufacturing a dental restoration can be removed. This opens up the possibility of draining material after it has not been used at all or has only been used in part for manufacturing a portion of a dental restoration. This is particularly advantageous if a subsequent portion of the dental restoration is to be manufactured from a different material. In the event that the material is not to be used at all for manufacturing a dental restoration, a subsequently arranged material is thus made available. This configuration is relevant in particular if at least a first material and a second material are arranged in succession in the receiving space in a discharge direction.

In one option, drained first material and/or drained second material may be collected in a receiving container. It will be appreciated that the order of the first material and the second material is reversed in the receiving container by comparison with the material storage container. Depending on the material, the use of a receiving container can promote or make possible reusability or disposal of materials which are not used for additively manufacturing the dental restoration.

It will be appreciated that in a case where the method for additively manufacturing the dental restoration is carried out according to the second alternative, meaning that a first portion of a component layer is created from the first material and a second portion of said component layer is created from the second material, a boundary between the first material and the second material or a progression of the material characteristic may be fixed in the space in which the dental restoration is to be manufactured, in other words in the construction space. The desired different material characteristics or the desired progression of the material characteristic within the dental restoration can also be achieved or at least influenced by positioning the dental restoration to be manufactured in such a way, relative to the boundary between the first material and the second material or relative to the spatially fixed progression of the material characteristic, that the desired properties are achieved.

In connection with all of the aspects of the present invention, in other words in connection with a material storage container according to the invention, a method according to the invention for filling a material storage container, a device according to the invention for additively manufacturing a dental restoration and a method according to the invention for additively manufacturing a dental restoration, all of the materials, in other words at least the first material and the second material, would need to be flowable at least during their processing. In particular, the materials used are liquids at least during their processing, it being possible for the viscosities of the materials to be substantially the same, similar or different. In another variant, the materials may be pasty, in other words may have a significantly higher viscosity than liquid water at a temperature of 23 °C. Optionally, it is conceivable to heat the materials if necessary in order to reduce the viscosity.

Materials for stereolithographic processing are preferably adjusted in such a way that their viscosity, depending on the material temperature during the processing process, is in the range of 100 mPa*s to 100 Pa*s, preferably 250 mPa*s to 50 Pa*s, particularly preferably 500 mPa*s to 49 Pa*s. The material temperature during the processing process is preferably in the range of 10 °C to 70 °C, particularly preferably 20 °C to 65 °C or 30 °C to 60 °C

In this context, the viscosity is usually determined at 23 °C, in other words at room temperature, using a plate-on-plate viscometer (shear rate 10/s). It will be appreciated that features, effects, and/or advantages mentioned in connection with one of the material storage container according to the invention, the method according to the invention for filling a material storage container, the device according to the invention for additively manufacturing a dental restoration, and the method according to the invention for additively manufacturing a dental restoration also apply to the others of the material storage container according to the invention, the method according to the invention for filling a material storage container, the device according to the invention for additively manufacturing a dental restoration, and the method according to the invention for additively manufacturing a dental restoration.

### BRIEF DESCRIPTION OF THE DRAWINGS

The invention is explained in the following with reference to various embodiments, which are shown in the accompanying drawings, in which:

FIG. 1 shows a first example of a device according to the invention for additively manufacturing a dental restoration in a first operating state, the device comprising a material storage container according to the invention, and a method according to the invention for additively manufacturing a dental restoration being carried out by means of the device,

FIG. 2 shows the device of FIG. 1 in a second operating state,

FIG. 3 shows a second example of a device according to the invention for additively manufacturing a dental restoration in a first operating state,

FIG. 4 shows the device of FIG. 3 in a second operating state,

FIG. 5 shows a third example of a device according to the invention for additively manufacturing a dental restoration in a first operating state,

FIG. 6 shows the device of FIG. 5 in a second operating state,

FIG. 7 is a section through the device of FIG. 5 along the plane VII-VII,

FIG. 8 is a section through the device of FIG. 6 along the plane VIII-VIII,

FIG. 9 shows a fourth example of a device according to the invention for additively manufacturing a dental restoration in a first operating state,

FIG. 10 shows the device of FIG. 9 in a second operating state,

FIG. 11 is a section through the device of FIG. 9 along the plane XI-XI,

FIG. 12 is a section through the device of FIG. 10 along the plane XII-XII,

FIG. 13 is a section through the device of FIG. 10 along the plane XIII-XIII,

FIG. 14 shows a fifth example of a device according to the invention for additively manufacturing a dental restoration in a first operating state,

FIG. 15 shows the device of FIG. 14 in a second operating state,

FIG. 16 shows a sixth example of a device according to the invention for additively manufacturing a dental restoration in a first operating state,

FIG. 17 shows the device of FIG. 16 in a second operating state,

FIG. 18 shows a seventh example of a device according to the invention for additively manufacturing a dental restoration in a first operating state,

FIG. 19 shows the device of FIG. 18 in a second operating state,

FIG. 20 shows the device of FIG. 18 in a third operating state,

FIG. 21 shows the device of FIG. 18 in a fourth operating state,

FIG. 22 shows the device of FIG. 18 in a fifth operating state,

FIG. 23 shows an eighth example of a device according to the invention for additively manufacturing a dental restoration in a first operating state,

FIG. 24 shows the device of FIG. 23 in a second operating state,

FIG. 25 shows a ninth example of a device according to the invention for additively manufacturing a dental restoration in a first operating state,

FIG. 26 shows the device of FIG. 25 in a second operating state,

FIG. 27 shows a tenth example of a device according to the invention for additively manufacturing a dental restoration in a first operating state,

FIG. 28 shows the device of FIG. 27 in a second operating state,

FIG. 29 shows an eleventh example of a device according to the invention for additively manufacturing a dental restoration in a first operating state,

FIG. 30 shows the device of FIG. 29 in a second operating state,

FIG. 31 shows a twelfth example of a device according to the invention for additively manufacturing a dental restoration in a first operating state,

FIG. 32 shows the device of FIG. 31 in a second operating state,

FIGS. 33 to 35 show different operating states of a variant of a material storage container according to the invention, which has separating elements,

FIGS. 36 to 38 show different operating states of another variant of a material storage container according to the invention, which has separating elements,

FIGS. 40 to 42 show different operating states of a further variant of a material storage container according to the invention, which has separating elements,

FIGS. 43 to 46 are illustrations of a method according to the invention for filling a material storage container, and

FIGS. 47 and 48 show a thirteenth example of a device according to the invention for additive manufacturing, wherein the device comprises a material supply container according to the invention and wherein a method according to the invention for additive manufacturing of a dental restoration may be carried out by means of the device.

### DETAILED DESCRIPTION

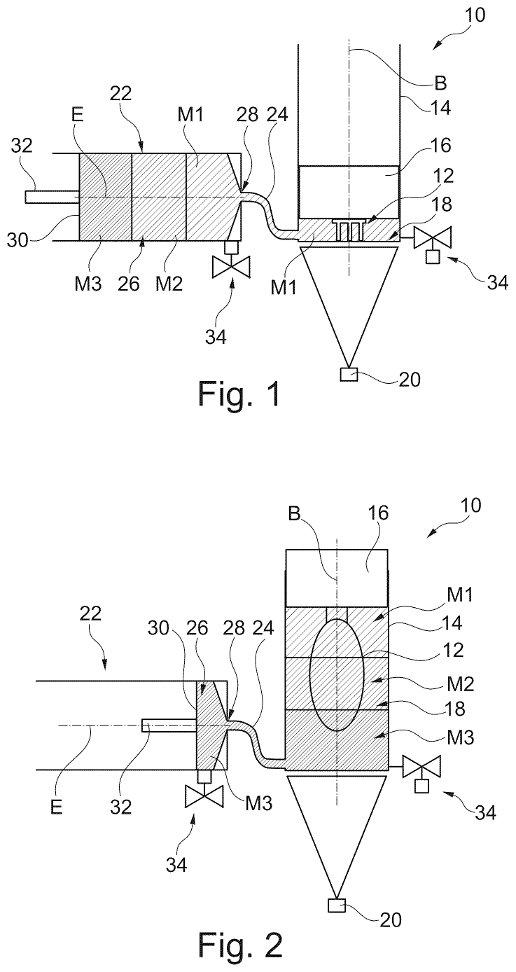

FIGS. 1 and 2 show a first example of a device 10 for additively manufacturing a dental restoration 12. FIG. 1 shows a first operating state, which coincides with the start of the additive manufacture of the dental restoration 12, and FIG. 2 shows a second operating state, which coincides with the end of the additive manufacture of the dental restoration 12.

It will be appreciated that the dental restoration 12 is merely shown schematically in the drawings. By way of example, the dental restoration 12 is a crown.

The device 10 comprises a construction space housing 14 which has the shape of a cylinder closed on one side and extending in a construction direction B.

Inside the construction space housing 14, a construction platform 16 is guided in such a way that the construction platform 16 can be moved, in other words displaced, in the construction direction B.

The construction space housing 14 and the construction platform 16 thus delimit a construction space 18 in which the dental restoration 12 can be manufactured, as will be explained in greater detail in the following. The construction space 18 is thus also substantially cylindrical, circular-cylindrical in the example shown, an associated cylinder axis coinciding with the construction direction B. It will be appreciated that other cross-sectional shapes are also possible in other examples.

Furthermore, the closed end of the construction space housing 14 is transparent at least in portions. An exposure unit 20 (merely shown schematically) is arranged at the closed end of the construction space housing 14 but outside the construction space 18.

The device 10 additionally comprises a material storage container 22, which is coupled to the construction space 18 in a material-conducting manner. In the embodiment shown, the material storage container 22 and the construction space 18 are coupled in a material-conducting manner via a line 24.

The material storage container 22 comprises a receiving space 26 which is substantially cylindrical, for example circular-cylindrical, and which extends along a cylinder axis. A supply port 28 is arranged centrally at a first end of the receiving space 26, and is coupled to the receiving space 26 in a material-conducting manner, in such a way that material can be supplied from the receiving space 26 via the supply port 28 for additively manufacturing the dental restoration 12. In the example shown, the line 24 is connected to the supply port 28.

On an end face of the cylindrical receiving space 26 opposite the supply port 28, the receiving space 26 is delimited by a movable wall 30. This movable wall is coupled to a drive 32 (merely shown schematically) in such a way that material can be pushed out of the receiving space 26 by moving the wall 30 in the direction of the supply port 28. The direction in which the wall 30 can be moved is therefore also referred to as the discharge direction E. The discharge direction E substantially coincides with the cylinder axis of the cylindrical receiving space 26. As a result of the coupling of the material storage container 22 and the construction space 18 via the line 24, material is thus supplied in the construction space 18.

The device 10 shown in the drawings for additively manufacturing a dental restoration 12 operates by stereolithography. This means that the dental restoration 12 is built up layer by layer in that material for one component layer is introduced from the material storage container 22 into the construction space 18 by actuating the drive 32 and displacing the wall 30. At the same time, the construction platform is moved in such a way that a volume increment resulting from the displacement of the wall 30 corresponds to a volume increment resulting from the displacement of the construction platform 16. The device 10 represents a closed system, in which the materials used for additively manufacturing the dental restoration 12 are always shielded from the environment, in particular from ambient air, by components of the device 10. As a result of the closed nature of the system, the construction platform 16 and the wall 30 are also hydraulically coupled via the materials present in the construction space 18 and/or the material storage container 22. As a result of this configuration, the construction platform 16 may merely be mounted movably but without its own drive. The construction platform 16 is then driven indirectly by the drive 32 and the hydraulic coupling.

In the event that the device 10 has an optional drain port 34, which will be explained in greater detail in the following, it may also be necessary for the construction platform 16 to be capable of being locked, in other words selectively prevented from moving. This prevents movement of the construction platform 16 when material is being drained through the drain port 34.

The material of the component layer is then cured in a location-specific manner using the exposure unit 20. This procedure is repeated until the dental restoration 12 is completely manufactured from numerous component layers.

In the example of FIG. 1, a total of three materials are arranged in the receiving space 26, in other words a first material M1, a second material M2 and a third material M3.

These materials M1, M2, M3 differ in at least one material characteristic which describes an optical material property, in particular a material colour and/or a translucency, a mechanical material property and/or a chemical material property.

For simpler explanations, it is assumed in the following that three materials M1, M2, M3 differ in colour.

In the embodiment of FIG. 1, the three materials M1, M2, M3 are arranged in succession in the discharge direction E of the receiving space 26.

The three materials M1, M2, M3 each form discrete macroscopic layers. This means that, starting from the supply port 28, a macroscopic layer of the first material M1 is initially arranged; subsequently, in the direction towards the wall 30, a macroscopic layer of the second material M2 is adjacent to the macroscopic layer of the first material M1; and in turn a macroscopic layer of the third material M3 is adjacent to this in the direction towards the wall 30.

Using the device 10, the dental restoration 12 can thus be manufactured layer by layer by the stereolithography method described above. As a result of the arrangement of the materials M1, M2, M3 in the receiving space 26, a first portion of the dental restoration 12 is initially manufactured from the first material M1. This portion comprises one or more component layers. Subsequently, a second portion of the dental restoration 12 is manufactured from the second material M2. This portion also comprises one or more component layers. After that, a third portion of the dental restoration 12 is manufactured from the third material M3. The third portion also comprises one or more component layers.

In the illustrative example shown of a dental restoration 12, the first portion has a lighter colour than the second portion. The second portion, in turn, has a lighter colour than the third portion.

This becomes clear when the first operating state in FIG. 1 is compared with the second operating state in FIG. 2.

In addition, it can be seen from the illustration of FIG. 2 that a colouring of the dental restoration 12 can be influenced by how the dental restoration 12 is arranged within the manufactured layers of the three materials M1, M2, M3, in other words within the construction space 18.

Optionally, the material storage container 22 further comprises a drain port 34. This makes controlled removal possible of material which is not to be used for additively manufacturing the dental restoration 12. The material may for example be transferred to a waste container (not shown in greater detail).

Alternatively or additionally, a drain port 34 of this type is provided on the construction space housing 14.

If a drain port 34 is provided on the construction space housing 14 or on the material storage container 22, the first material M1, second material M2 or third material M3 can be drained during the additive manufacture of the dental restoration 12, in such a way that the full amount of material present in the receiving space 26 does not have to be used. This provides a further option for influencing the construction of the dental restoration from the materials M1, M2, M3. In this context, in particular an amount of first material M1, second material M2 and/or third material M3 used for manufacturing the dental restoration 12 can be substantially freely selected. This also makes it possible for the properties of the dental restoration 12 to be selectively adjusted, for example as regards the colour of the three materials M1, M2, M3.

The variant where the drain port 34 is provided on the material storage container 22 also has the advantage that the first material M1, second material M2 and/or third material M3 to be drained do not have to be passed through the construction space 18, where they could potentially mix with material located therein.

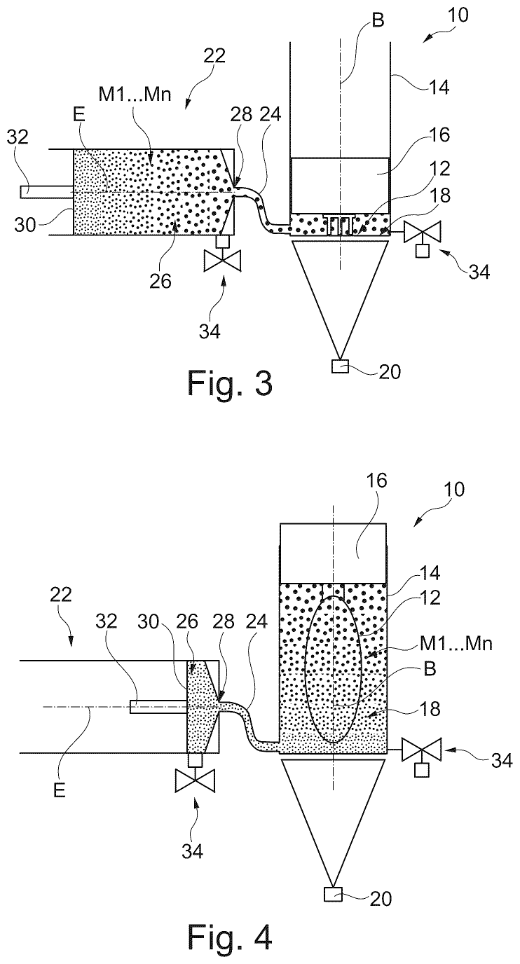

FIGS. 3 and 4 show a second example of a device 10 for additively manufacturing a dental restoration 12. In the following, only the differences from the first example will be discussed.

These relate to the materials in the receiving space 26.

By contrast with the first example, in the second example numerous materials, in other words significantly more than three, which differ in at least one material characteristic are arranged in the receiving space 26.

The numerous materials are arranged in succession in the discharge direction of the receiving space 26, resulting in a macroscopically continuous progression of the at least one material characteristic.

Assuming again that the material characteristic relates to a colour, this results in a continuous colour gradient in the discharge direction E.

Thus, using the method explained in principle previously, a dental restoration 12 can be manufactured which also has a continuous progression of the material characteristic, for example, the colour. Again, the progression of the material characteristic can be further influenced by positioning the dental restoration 12 within the construction space 18. Furthermore, the optional drain ports 34 are also provided in the embodiment of FIGS. 3 and 4.

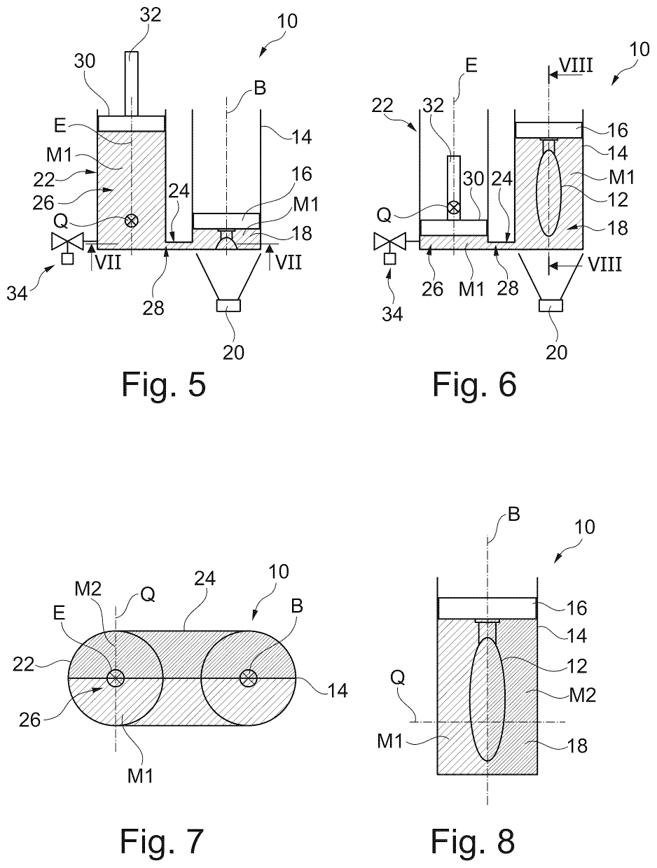

FIGS. 5 and 6 show a third example of a device 10 for additively manufacturing a dental restoration 12. In the following, only the differences from the first example and from the second example will be discussed.

This difference relates to the arrangement of the materials.

In the third example, only two materials M1, M2 are arranged in the receiving space 26.

By contrast with the previous examples, the first material M1 and the second material M2 are arranged in succession in a direction Q transverse to a discharge direction.

In the discharge direction E, the first material M1 and the second material M2 are arranged side by side.

This means that movement of the wall 30 always causes two different materials M1, M2 to arrive in the construction space 18 side by side. This becomes particularly clear when the sectional view in FIG. 7 is considered.

Again, for simplicity, it can be assumed that the materials M1, M2 differ in colour.

Thus, the dental restoration 12 can be manufactured, but now different portions of the dental restoration 12 are not made of different materials M1, M2 in the construction direction B, but rather the different portions of the dental restoration result from the different materials M1, M2, which both extend in the construction direction B (see in particular FIG. 8).

If a method for additively manufacturing the dental restoration 12 is carried out using the device 10 of FIGS. 5 and 6, each of the manufactured component layers is created from both the first material M1 and the second material M2. Thus, a first portion of each layer is manufactured from the first material M1, and a second portion of each layer is manufactured from the second material M2.

Even though the third example was explained using discrete macroscopic layers of the first material M1 and the second material M2, it will be appreciated that in the third example it is also possible to use numerous materials arranged in succession transverse to the discharge direction E of the receiving space 26, so as to result in a macroscopically continuous progression of the at least one material characteristic. In other words, the continuous progression of the material characteristic, as explained in the second example, can also be combined with the sequential arrangement of the materials in a direction Q transverse to the discharge direction E.

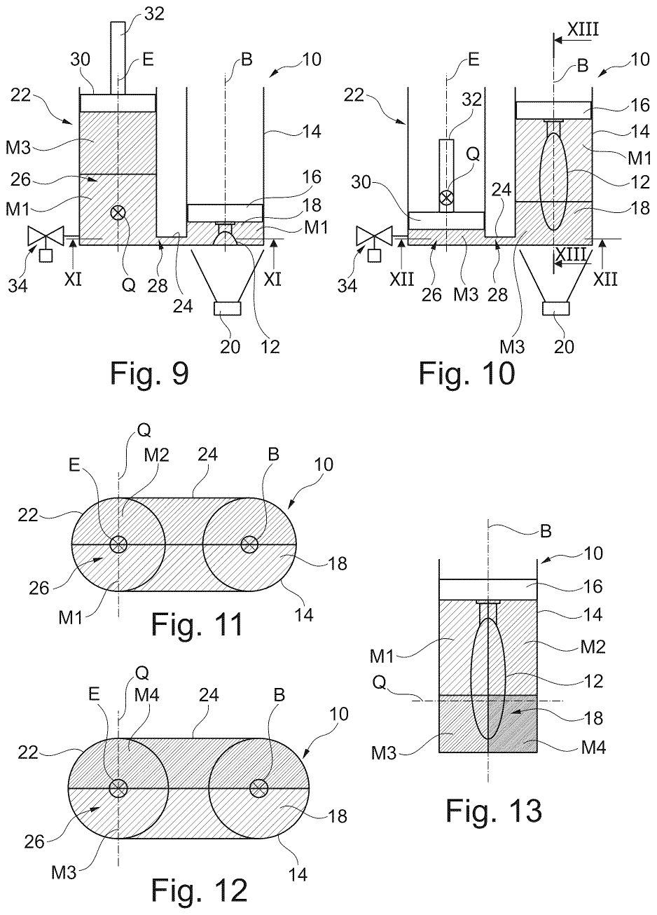

FIGS. 9 and 10 show a fourth example of a device 10 for additively manufacturing a dental restoration 12. In the following, only the differences from the previous examples will be discussed.

These differences relate to the arrangement of the materials.

In the fourth example, a total of four materials M1, M2, M3, M4 are arranged in the material storage container 22, which materials differ in at least one material characteristic.

The materials are arranged in succession both in the discharge direction E and in a direction transverse to the discharge direction E.

More precisely, the first material M1 and the second material M2 are arranged in a first portion arranged adjacent to the supply port 28 in the discharge direction E, the first material M1 and the second material M2 being arranged in succession within this portion in a direction Q transverse to the discharge direction E.

In the direction towards the wall 30, this first portion is adjoined by a second portion, which thus lies between the first portion and the wall 30 in the discharge direction E. A third material M3 and a fourth material M4 are arranged within the second portion, the third material M3 and the fourth material M4 being arranged in succession within the second portion in a direction Q transverse to the discharge direction E.

The material storage container 22 according to the fourth example may thus be regarded as a combination of the material storage containers 22 of the first example and of the third example.

If the dental restoration 12 is manufactured using the device 10 of FIGS. 9 and 10, a first portion of the dental restoration 12 is initially manufactured from both the first material M1 and the second material M2. Subsequently, a second portion of the dental restoration 12 is manufactured from both the third material M3 and the fourth material M4. The first portion of the dental restoration 12 and the second portion of the dental restoration 12 are adjacent in the construction direction B.

As usual, in addition to the selection of the materials M1, M2, M3, M4, the dental restoration 12 can also be influenced by how it is arranged within the construction space 18 (see FIG. 13).

Even though the fourth example was explained using discrete macroscopic layers of the first material M1, the second material M2, the third material M3, and the fourth material M4, it will be appreciated that in the fourth example it is also possible to use numerous materials arranged in succession so as to result in a macroscopically continuous progression of the at least one material characteristic. This may apply to the materials arranged in succession in the discharge direction E and/or to the materials arranged in succession transverse to the discharge direction. In other words, the continuous progression of the material characteristic, as explained in the second example, may also be combined with the fourth example.

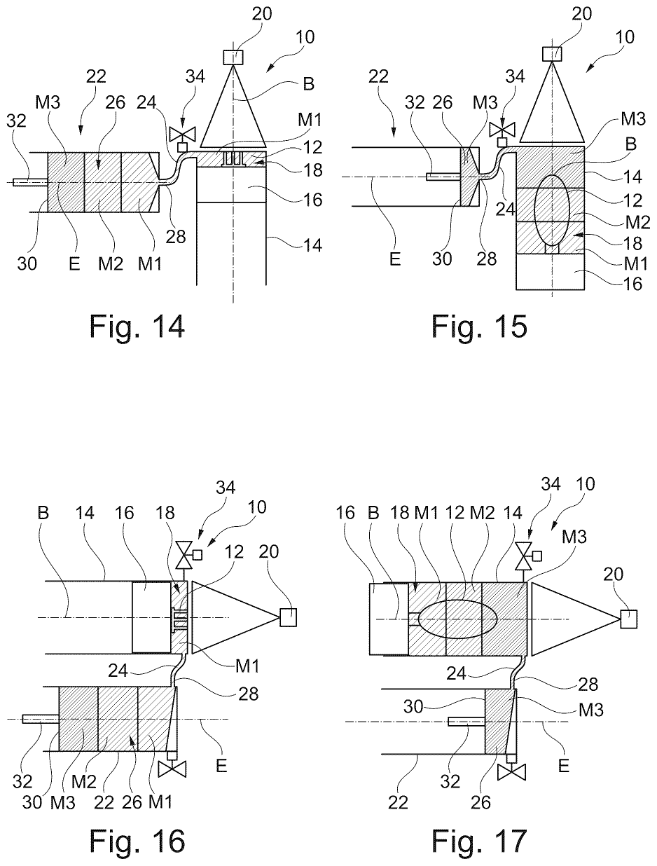

FIGS. 14 and 15 show a fifth example of a device 10 for additively manufacturing a dental restoration 12. In the following, only the differences from the previous examples will be discussed.

The fifth example is a variant on the first example, only the construction direction of the dental restoration 12 having been changed. Whereas in the first example the dental restoration 12 is built from bottom to top, or bottom-up, in the fifth example it is built from top to bottom, or top-down.

FIGS. 16 and 17 show a sixth example of a device 10 for additively manufacturing a dental restoration 12. In the following, only the differences from the previous examples will be discussed.

The sixth example is also a variant on the first example, only the construction direction of the dental restoration having been changed. Whereas in the first example the dental restoration 12 is built from bottom to top, or bottom-up, in the sixth example it is built from one side to the other.

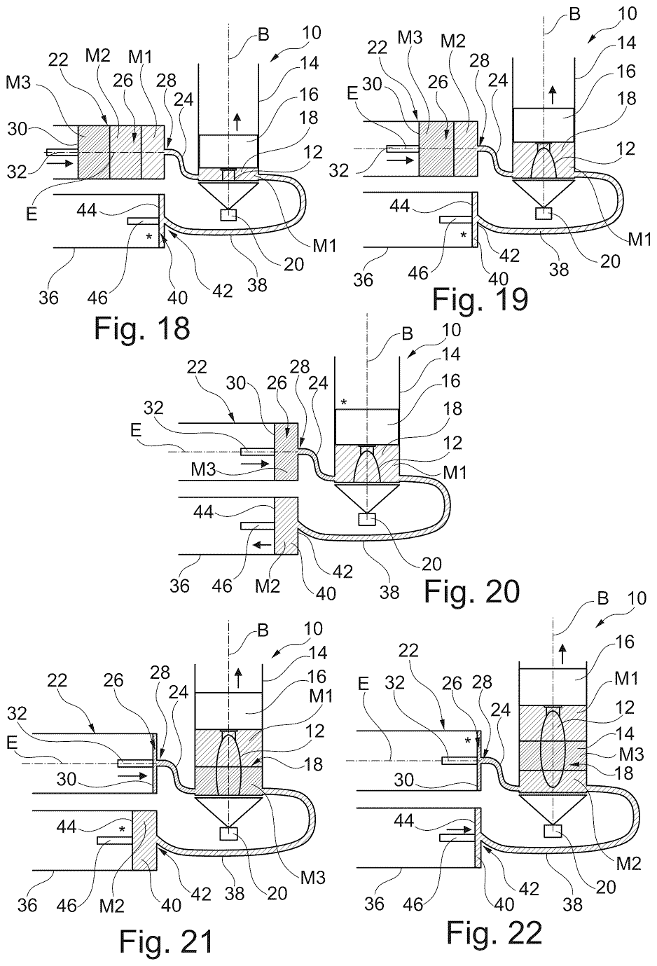

FIG. 18 to 22 show a seventh example of a device 10 for additively manufacturing a dental restoration 12. In the following, only the differences from the previous examples will be discussed.

The seventh example may likewise be considered to be a variant of the first example.

The device 10 additionally has a receiving container 36.

This is connected to the construction space 18 in a material-conducting manner via an additional line 38.

Like the material storage container 22, the receiving container 36 also comprises a receiving space 40, which is connected on one side to a material supply port 42 and delimited on the other side by a movable wall 44. The wall 44 is also coupled to a drive 46 (merely shown schematically) in such a way that it can be moved selectively.

By actuating the wall 30, the wall 44 and the construction platform 16 accordingly, the following elements or sub-steps of a method for additively manufacturing a dental restoration 12 can now be implemented.

Material can be introduced from the material storage container 22 into the construction space 18. For this purpose, the wall 30 must be moved towards the supply port 28 of the material storage container 22. The construction platform 16 must be raised accordingly, in other words moved away from the exposure unit 20. At the same time, the wall 44 is held still, meaning that the wall 44 remains stationary.

Similarly, it is possible to introduce material from the receiving container 36, if present, into the construction space 18. For this purpose, the wall 44 is to be moved towards the supply port 42 of the receiving container 36. The construction platform 16 must be raised accordingly, in other words moved away from the exposure unit 20. At the same time, the wall 30 is held still, meaning that the wall 30 remains stationary.

In addition, material can be transferred from the construction space 18 or from the material storage container 22 into the receiving container 36. For this purpose, the wall 30 of the material storage container 22 is moved towards the supply port 28. The wall 44 of the receiving container 36 moves away from the supply port 42 of the receiving container 36 in a corresponding manner. The construction platform 16 does not move in this context.

Conversely, it is also possible to transfer material from the receiving container 36, if present, or from the construction space 18 into the material supply container 22. For this purpose, the wall 44 of the receiving container 36 is moved towards the supply port 42 of the receiving container 36. The wall 30 of the material supply container 22 is moved away from the supply port 28. Again, the construction platform 16 does not move.

These elements or sub-steps of a method for additively manufacturing the dental restoration 12 may be combined in any desired manner. Movements of the walls 30, 44 and of the construction platform 16 are represented by arrows in FIG. 18 to 22. Blocking of one of the walls 30, 44 or of the construction platform 16 is represented by a star. An illustrative example is explained in the following with reference to FIG. 18 to 22.

Initiall, a first portion of the dental restoration 12 is constructed from the first material M1. This first portion comprises a plurality of component layers. For this purpose, the wall 30 of the material storage container 22 is successively moved towards the supply port 28. The construction platform 16 is successively moved away from the exposure unit 20 in a corresponding manner. During the manufacture of the first portion of the dental restoration 12, the wall 44 of the receiving container 36 does not move. Since no material is present in the receiving container 36 in the embodiment of FIG. 18, it may also be said that the receiving container 36 remains closed (see in particular FIGS. 18 and 19).

In the embodiment shown, the first material M1 is used entirely to construct the first portion of the dental restoration 12.

However, a subsequent second portion of the dental restoration 12 should not be manufactured from the second material M2, but rather from the third material M3.

For this reason, after the first portion of the dental restoration 12 is completed, the construction platform 16 is held stationary. Then, by actuating the wall 30 of the material storage container 22, the second material M2 is transferred through the construction space 18, in other words through the lower portion of the construction space 18, into the receiving container 36. For this purpose, the wall 44 of the receiving container 36 is moved away from the supply port 42 of the receiving container 36 in a corresponding manner (see in particular FIGS. 19 and 20).

This takes place until substantially all of the second material M2 is in the receiving space 40 of the receiving container 36.

Subsequently, the second portion of the dental restoration 12 is manufactured using the third material M3. For this purpose, the wall 30 is again moved towards the supply port 28 of the material storage container 22, and the construction platform 16 is moved away from the exposure unit 20 in a corresponding manner. The wall 44 is not moved in this context (see in particular FIGS. 20 and 21).

A subsequent third portion of the dental restoration 12 is now to be manufactured from second material M2. Once the second material M2 has been transferred beforehand into the receiving container 36, the wall 44 of the receiving container 36 must be moved towards the supply port 42 of the receiving container 36 for this purpose. The construction platform 16 must be raised accordingly, in other words moved away from the exposure unit 20. During the manufacture of the third portion, the wall 30 of the material storage container 22 is not moved (see in particular FIGS. 21 and 22).

Thus, overall, by using the receiving container 36, an order in which materials M1, M2, and M3 are arranged in the material storage container 22 can be decoupled from an order in which the materials M1, M2, M3 are used to construct the dental restoration 12.

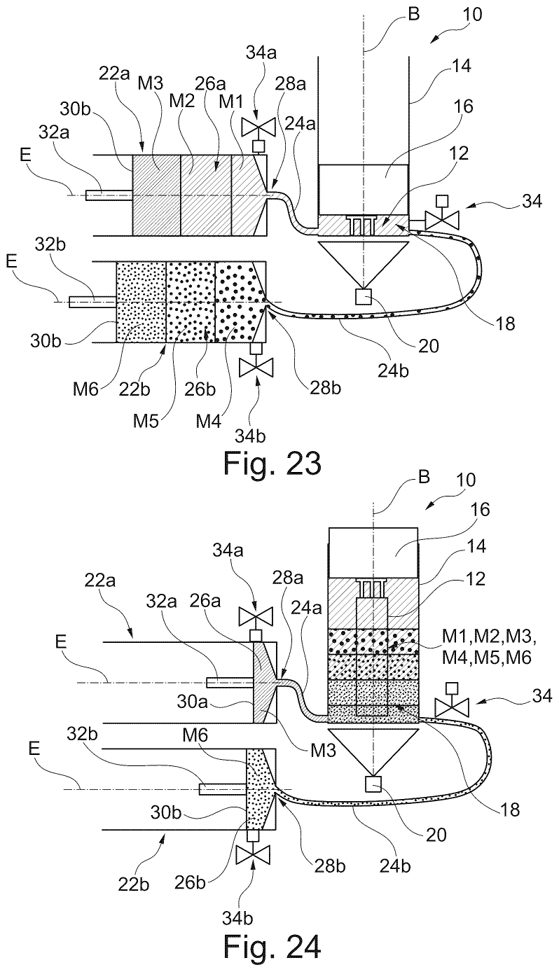

FIGS. 23 and 24 show an eighth example of a device 10 for additively manufacturing a dental restoration 12. In the following, only the differences from the previous examples will be discussed.

The eighth example differs from the previous examples in particular in that a total of two material storage containers 22 are provided as components of the device 10. For clearer differentiation, the material storage containers 22 are referred to in the following with the suffixes a and b. This also applies to components of the material storage containers 22 and to components or assemblies connected thereto.

The two material storage containers 22a, 22b are each connected to the construction space 18 via an associated line 24a, 24 b.

In the first material storage container 22a, a total of three materials M1, M2, M3 are arranged in macroscopic layers in the discharge direction E.

In the embodiment shown, the materials M1, M2, M3 differ, by way of example, in colour.

There is also a total of three materials, referred to as the fourth material M4, the fifth material M5, and the sixth material M6, arranged in the second material storage container 22b. These materials M4, M5, M6 are also arranged in macroscopic layers in the discharge direction E.

In the embodiment shown, the materials M4, M5, M6 differ, by way of example, in translucency.

The device 10 can thus be used to manufacture a dental restoration 12 having portions of different colours. This is achieved by using the materials M1, M2, M3 of different colours.

At the same time, the dental restoration can have 12 portions of different translucencies. This is achieved by using the materials M4, M5, M6 of different translucencies.

In other words, during the additive manufacture of the dental restoration 12 in the construction space 18, a material from the material storage container 22a and a material from the material storage container 22b may be mixed to create a component layer. However, this is optional. It is also possible to use only one material from the material storage container 22a or one material from the material storage container 22b to construct a component layer.

In the event that both a material from the material storage container 22a and a material from the material storage container 22b are used, a mixing ratio can be adjusted in the desired manner by moving the walls 30a, 30b.

Likewise, each of the material storage containers 22a, 22b is equipped with an optional drain port 34a, 34b, in such a way that materials from both material storage containers 22a, 22b can be transferred to a waste container if necessary.

Thus, overall, a dental restoration 12 can be manufactured which has not only a colour gradient but also a translucency gradient.

It will be appreciated that the device 10 of FIGS. 23 and 24, which has been explained here using macroscopically discrete material layers, may of course also be varied in such a way that numerous materials are arranged in one or both of the material storage containers 22a, 22b so as to result in a macroscopically continuous progression of the associated material characteristic, for example the colour and/or the translucency.

It will also be appreciated that the embodiment of FIGS. 23 and 24 may also be combined with the embodiment of FIG. 18 to 22, and so the order of the materials in the material storage containers 22a and/or 22b can be decoupled from the order of the materials in the dental restoration 12.

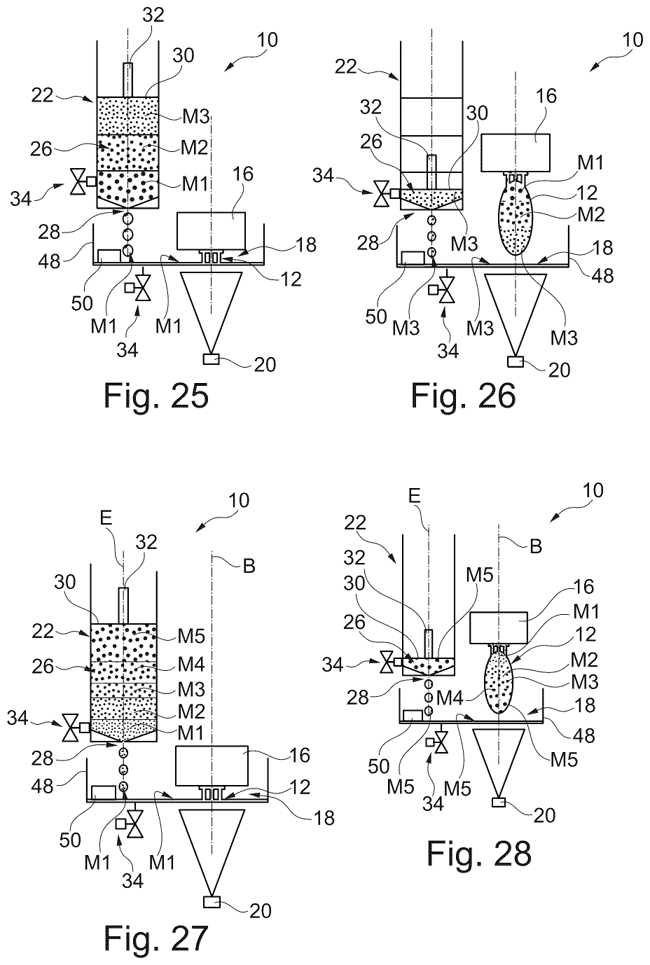

FIGS. 25 and 26 show a ninth example of a device 10 for additively manufacturing a dental restoration 12. In the following, only the differences from the previous examples will be discussed.

The ninth example can be explained well in particular by comparison with the first example.

The device 10 according to the ninth example differs from the device 10 according to the first example in that the device 10 according to the ninth example is configured as an open system whilst the device 10 according to the first example is configured as a closed system.

This means that the device 10 according to the ninth example has an upwardly open trough 48 into which material for additively manufacturing the dental restoration 12 is introduced by means of the supply port 28 of the material storage container 22.

In principle, the fill level of the trough 48 can vary as long as a particular minimum fill level necessary for carrying out the additive manufacture process is maintained.

So as to keep material inside the trough 48 homogeneous or to homogenise it if necessary, a mixing device 50, which may also be referred to as a mixer, is additionally arranged at the bottom of the trough 48.

In a similar manner to the first example, the bottom of the trough 48 is transparent at least in portions, in such a way that, by means of an exposure unit 20 arranged below the bottom of the trough 48, material in the interior of the trough 48 can be cured in a location-selective manner by exposure.

Because the fill level in the trough 48 can vary, the device 10 according to the ninth example further differs from the first example in that, in spite of the first material M1, the second material M2 and the third material M3 being supplied in the material storage container 22 in the form of macroscopically discrete layers, a gentle, in other words continuous, change in the material characteristic can nevertheless be implemented in the dental restoration 12 to be manufactured.

This is because it is possible to mix different materials, arranged in succession in the material storage container 22, in the trough 48.

Thus, in a purely illustrative example, during the method for additively manufacturing the dental restoration 12, starting from a situation where only first material M1 is present in the trough 48, at some time the last remnant of first material M1 is added from the material storage container 22 into the trough 48. If the material storage container 22 is subsequently discharged further, second material M2 is thus added to the trough 48. As the manufacturing process continues, a mixture of first material M1 and second material M2 occurs in the trough 48, a proportion of the second material M2 increasing. This also applies at the transition from the second material M2 to the third material M3.

It will be appreciated that in the ninth example a drain port 34 may also optionally be provided on the material storage container 22. Alternatively or additionally, a drain port 34 may be provided on the trough 48. This results in the advantages explained previously.

FIGS. 27 and 28 show a tenth example of a device 10 for additively manufacturing a dental restoration 12. In the following, only the differences from the previous examples will be discussed.

The tenth example may be regarded as a variant of the ninth example, the material storage container 22 of the tenth example merely differing from the material storage container of the ninth example in that a total of five materials M1, M2, M3, M4, M5 are arranged therein.

In addition to manufacturing a dental restoration 12, the example of FIGS. 27 and 28 is also particularly well suited to manufacturing pieces of jewellery or sensors.

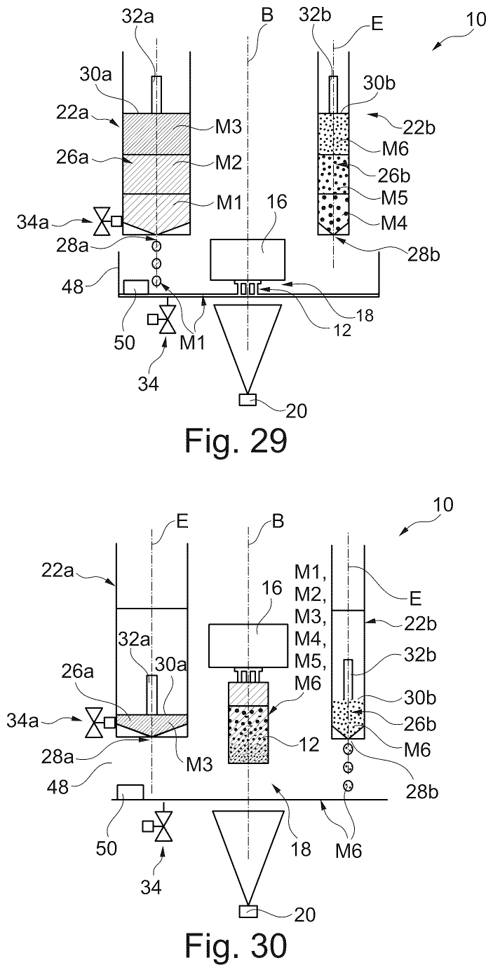

FIGS. 29 and 30 show an eleventh example of a device 10 for additively manufacturing a dental restoration 12. In the following, only the differences from the previous examples will be discussed.

The eleventh example can be explained particularly well with reference to the eighth example, the eighth example relating to a closed system and the eleventh example to an open system.

Again, a total of two material storage containers 22 are provided as components of the device 10. For clearer differentiation, the material storage containers 22 are again referred to in the following with the suffixes a and b. This also applies to components of the material storage containers and to assemblies and components connected thereto.

The two material storage containers 22a, 22b are connected to the construction space 18 in a material-conducting manner. This means that material can be added to the trough 48 using both material storage containers 22a, 22b.

In the first material storage container 22a, a total of three materials M1, M2, M3 are arranged in macroscopic layers in the discharge direction E.

In the embodiment shown, the materials M1, M2, M3 differ, by way of example, in colour.

There is also a total of three materials, referred to as the fourth material M4, the fifth material M5, and the sixth material M6, arranged in the second material storage container 22b. These materials are also arranged in macroscopic layers in the discharge direction E.

In the embodiment shown, the materials M4, M5, M6 differ, by way of example, in translucency.

The device 10 can thus be used to manufacture a dental restoration 12 which has portions of different colours. This is achieved by using the materials M1, M2, M3 of different colours.

At the same time, the dental restoration can have 12 portions of different translucencies. This is achieved by using the materials M4, M5, M6 of different translucencies.

In other words, during the additive manufacture of the dental restoration 12 in the construction space 18, a material from the material storage container 22a and a material from the material storage container 22b may be mixed to create a component layer. However, this is optional. It is also possible to use only one material from the material storage container 22a or one material from the material storage container 22b to construct a component layer.

In the event that both a material from the material storage container 22a and a material from the material storage container 22b are used, a mixing ratio can be adjusted in the desired manner by moving the walls 30a, 30b.

Likewise, each of the material storage containers 22a, 22b is equipped with an optional drain port 34a, 34b, in such a way that materials from both material storage containers 22a, 22b can be transferred to a waste container if necessary.

Thus, overall, a dental restoration 12 can be manufactured which has not only a colour gradient but also a translucency gradient.

As explained previously for the ninth example, in the eleventh example, because the fill level in the trough 48 can vary, a gentle, in other words continuous, change in the material characteristic can be implemented in the dental restoration 12 to be manufactured, in spite of the materials M1, M2, M3 plus M4, M5 and M6 being supplied in the form of macroscopically discrete layers.

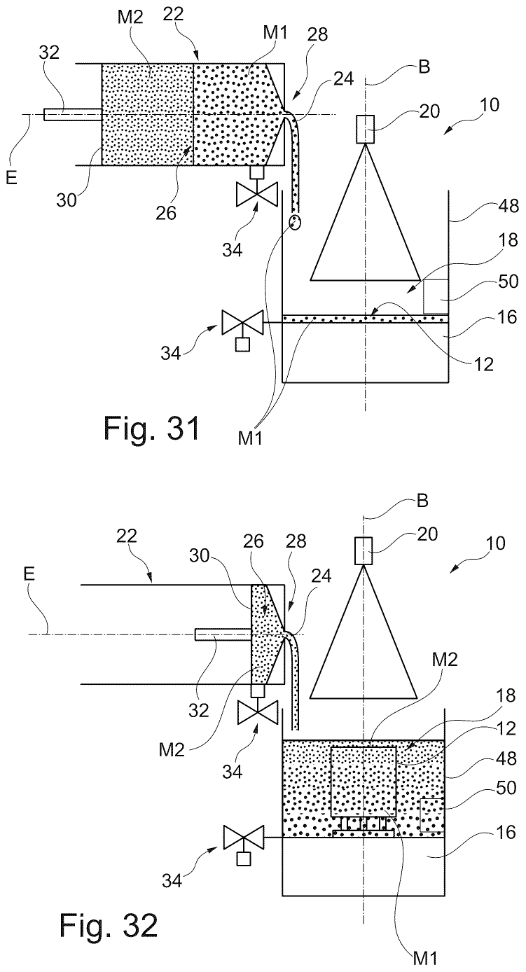

FIGS. 31 and 32 show a twelfth example of a device 10 for additively manufacturing a dental restoration 12. In the following, only the differences from the previous examples will be discussed.

The twelfth example is a variant on the ninth example, the construction direction of the dental restoration having been changed. Whereas in the ninth example, the dental restoration 12 is built from bottom to top, in other words bottom-up, in the twelfth example, it is built from top to bottom, in other words top-down.

Furthermore, in the twelfth example, the orientation of the material storage container 22 is horizontal instead of vertical.

As explained previously in many of the preceding examples, different materials, in other words at least a first material M1 and a second material M2, may be supplied in discrete macroscopic layers in the material storage container 22, the first material M1 and the second material M2 being arranged in succession in a discharge direction E.

So as reliably to separate the materials arranged in succession in the material storage container 22 in the discharge direction E, separating elements 52 may be provided which are arranged between adjacent materials, in other words between a first material M1 and a second material M2 or between a second material M2 and a third material M3 and so forth, so as to separate the adjacent materials from each other.

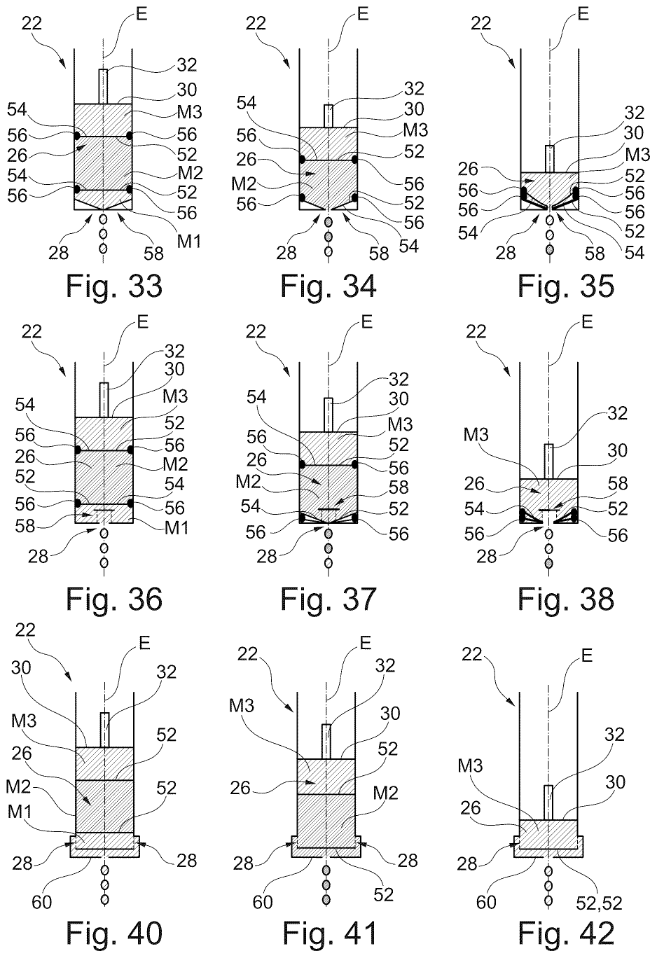

FIG. 33 to 35 show a first variant of a separating element 52 of this type in connection with an illustrative material storage container 22 in different operating states of the material storage container 22.

In this variant, the separating element comprises a film 54, which may also alternatively be configured as a membrane.

This film 54 extends substantially over the entire boundary layer between the materials to be separated. The separating element 52 of FIG. 33 to 35 additionally has a guide element 56, which in this embodiment is configured as a thickened edge portion of the film 54. The guide element 56 serves to guide the separating element 52 in the receiving space 26 in such a way that it can only move in the discharge direction E.

In the embodiment of FIG. 33 to 35, the material storage container 22 is additionally equipped with a perforation element 58.

The perforation element 58 serves to break open the separating element 52 when the material located downstream from the separating element 52 in the discharge direction E is to be supplied by means of the supply port 28 for additively manufacturing the dental restoration 12.

In the variant of FIG. 30 to 35, the perforation element 58 is formed on the one hand by an end portion, converging in a funnel shape, of the receiving space 26 and on the other hand by an opening which leads to the supply port 28.

Once the material located in front of the separating element 52 in the discharge direction E has been completely removed from the receiving space 26 of the material storage container 22, by further actuation of the wall 30 the film 54 is thus applied to the end portion, converging in a funnel shape, of the receiving space 26, and thus tensioned. In this way, the film 54 is placed, in a tensioned state, on the opening leading to the supply port 28. The mechanical properties of the film 54 are selected in such a way that it breaks in the region of this opening if the wall 30 is further actuated.

An alternative embodiment of a perforation element 58 is shown in FIG. 36 to 38.

In this variant, the perforation element 58 comprises a projection or a cover which lies in the discharge direction E at a particular distance above the supply port 28 and is offset into the interior of the receiving space 26.

In this way, when materials are removed from the material storage container 22, the film 54 of a separating element 52 can be applied to the projection or cover, in such a way that this portion of the film 54 prevents further movement in the discharge direction E. However, this does not apply to other portions of the film 54 which do not lie against the projection. This can also lead to a desired breaking or tearing of the film 54.

FIG. 40 to 42 show a further variant of a separating element 52. By contrast with the previously described separating elements 52, the separating elements shown in FIG. 40 to 42 are not configured to be broken open. Rather, these separating elements 52 are configured as comparatively stable discs which move in the discharge direction E when material is removed from the material storage container 22.

However, in the material storage container 22 of FIG. 40 to 42, the supply port 28 is not arranged centrally on the receiving space 26, but rather extends laterally or radially from the receiving space 26 with respect to the discharge direction E. Thus, in this material storage container 22, it is possible for a separating element 52 to come into axial contact with a supply-port-side end of the receiving space 26, but not to close the supply port 28 there, since said port actually extends away laterally. In this way, materials arranged in succession in the discharge direction E can reliably be kept separate by means of a separating element 52.

In the variant of FIG. 40 to 42, so as still to be able to connect the material storage container 22 centrally to a construction space 18 in a material-conducting manner, the material storage container 22 in this variant is additionally equipped with a collecting housing 60, through which material leaving the receiving space 26 via a lateral supply port is guided to a central connector.

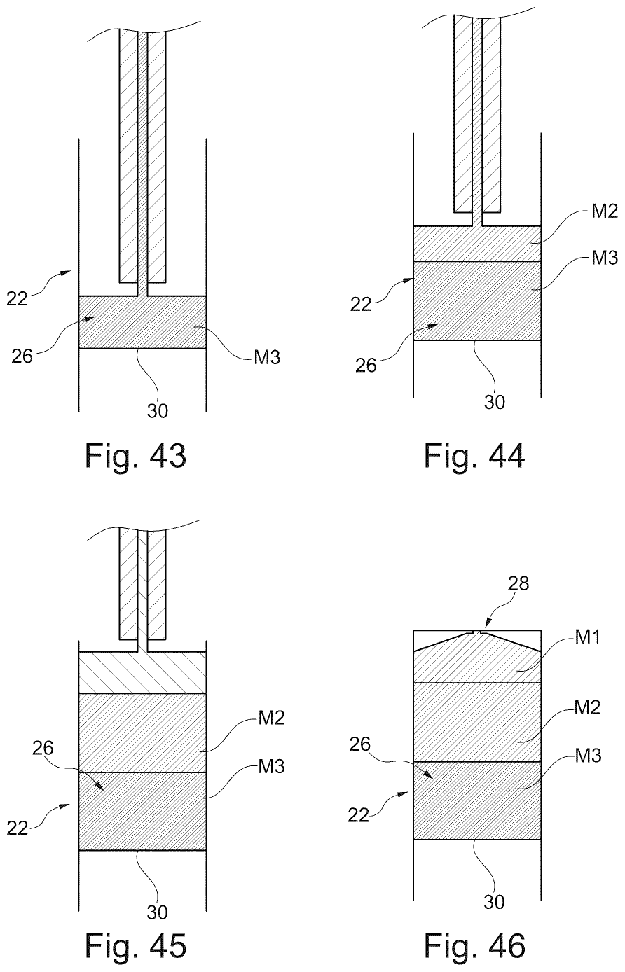

So as to use the material storage containers 22, with the materials arranged therein, in the manner described above with reference to a plurality of examples, it is necessary to fill the material storage containers 22 with the corresponding materials. This is explained with reference to FIG. 43 to 46.

This example relates to filling a material storage container 22 with materials which are arranged in succession in discrete macroscopic layers in the discharge direction.

Initially, a third material is introduced (see FIG. 43).

A tube, a pipe, or a needle of a syringe may be used for this purpose.

Optionally, the viscosity of the third material M3 is reduced or kept low before the introduction of the third material and/or during the introduction of the third material M3. This facilitates the introduction of the third material M3 into the receiving space 26. For example, a reduced viscosity may be achieved by heating the third material M3.

In the example of FIG. 43, the third material M3 is introduced into the receiving space 26 using a heated syringe.

Afterwards, it is optionally possible to wait until the viscosity of the third material M3 has increased again, or in simple terms until the third material M3 has become solid or more solid again.

Subsequently, a second material M2 is introduced into the receiving space 26 (see FIG. 44).

In this case too, the viscosity of the second material M2 may be reduced or kept low while it is introduced into the receiving space 26.

Again, in the example of FIG. 44, the second material M2 is introduced into the receiving space 26 using a heated syringe.

Again, there is subsequently a wait until the viscosity of the second material M2 has increased again.

Only then is the first material M1 introduced. This is done in the same manner explained previously in connection with the third material M3 and the second material M2.

Once the first material M1 has also been completely introduced into the receiving space 26, the receiving space is closed with a cap 62, on which the supply port 28 is also provided in the embodiment of FIG. 46.

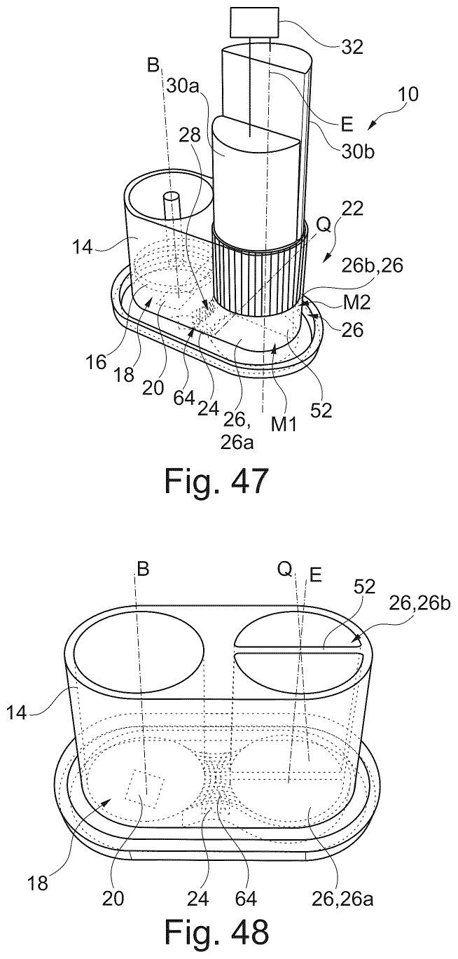

FIGS. 47 and 48 show a thirteenth example of a device 10 for additively manufacturing a dental restoration 12. FIG. 47 shows the device as a whole, with the construction space housing 14, the material storage container 22, and the line 24 shown transparently. FIG. 48 shows the device of FIG. 47 in a different view, wherein, in contrast to FIG. 47, the build platform 16 and the movable walls 30a, 30b are omitted.

The operational state as shown in FIG. 47 may be associated with the start of additively manufacturing the dental restoration 12. The dental restoration 12 to be manufactured is therefore not shown in detail.

Similar to the devices 10 as already described, also device 10 of the thirteenth example comprises a construction space housing 14, which has the shape of a cylinder closed on one side and extending along a construction direction B.

A construction platform 16 is guided inside the construction space housing 14 so that the construction platform 16 can move, i.e., translate, along the construction direction B.

The construction space housing 14 and the construction platform 16, thus, delimit a construction space 18 in which the dental restoration 12 can be produced. The construction space 18 is, thus, also essentially cylindrical, in the example shown circular cylindrical, with an associated cylinder axis coinciding with the construction direction B. It is understood that other cross-sectional shapes are also possible in other examples.

Furthermore, the closed end of the construction space housing 14 is designed to be transparent, at least in sections. An exposure unit 20, shown only schematically, is arranged at the closed end of the construction space housing 14, but outside the construction space 18.

The device 10 also comprises a material storage container 22, which is coupled to the construction space 18 in a material-conducting manner. In the embodiment shown, the material storage container 22 and the installation space 18 are coupled in a material-conducting manner via a line 24.

The material storage container 22 has a receiving space 26 that is essentially cylindrical, for example circular cylindrical, and extends along a cylinder axis. The circular cylindrical material storage container 22 and, thus, also the receiving space 26 are closed at one end.

In the thirteenth example, the receiving space 26 is further subdivided into two sections 26a, 26b by means of a separating element 52. The sections 26a, 26b are arranged one behind the other along a direction Q that is oriented transversely to an emptying direction E of the material storage container 22. The separating element 52 is designed as a fixed wall element. Moreover, the separating element is formed as an integral portion of the material storage container 22. This means that a peripheral wall of the material storage container 22, which laterally delimits the receiving space 26, i.e., in this case, the cylinder jacket, and the separating element 52 are formed integrally or are at least permanently connected during operation of the device 10.

Two different materials M1, M2 can, thus, be arranged in sections 26a, 26b of the receiving space 26. These materials M1, M2 are then also arranged one behind the other along a direction Q that is oriented transversely to an emptying direction E of the material storage container 22. The separating element 52 separates reliably from each other the materials M1, M2. The coupling of the receiving chamber 26 with the construction space 18 is designed in such a way that material M1, M2 from both sections 26a, 26b of the receiving space 26 may enter the line 24 via a supply port of the material storage container 22.

On an end face of the cylindrical receiving space 26 located opposite the supply port 28, each of the sections 26a, 26b of the receiving space 26 is delimited by a movable wall 30a, 30b, respectively.

These movable walls 30a, 30b are coupled to a drive 32, which is shown only schematically, so that material M1 can be pushed out of section 26a of the receiving space 26 by moving wall 30a toward the supply port 28, and so that material M2 can be pushed out of section 26b of the receiving space 26 by moving wall 30b toward the supply port 28.

The direction in which the walls 30a, 30b can move is therefore referred to as the discharge direction E. The discharge direction E essentially coincides with the cylinder axis of the cylindrical receiving chamber 26. Due to the coupling of the material storage container 22 and the construction chamber 18 via the line 24, material is supplied to the construction chamber 18 in this manner.

The device 10 for additively manufacture a dental restoration 12 as shown in FIGS. 47 and 48 functions according to the principle of stereolithography. This means that the dental restoration 12 is built up layer by layer by actuating the drive 32 and moving the walls 30a, 30b to introduce material for a layer of the dental restoration 12 from the material storage container 22 into the construction chamber 18. At the same time the construction platform 16 is moved in such a way that a volume increment resulting from the displacement of one of the walls 30a, 30b corresponds to a volume increment resulting from the displacement of the construction platform 16. The device 10 is a so-called closed system in which the materials M1, M2 used for additively manufacturing the dental restoration 12 are always shielded from the environment, in particular from ambient air, by components of the device 10. Due to the closed nature of the system, the construction platform 16 and the walls 30a, 30b are also hydraulically coupled via the Materials M1, M2 provided in the construction space 18 and/or in the material storage container 22. Due to this configuration, the construction platform 16 can only be supported in a movable manner, but does not require its own drive. The construction platform 16 is then indirectly driven by the drive 32 and the hydraulic coupling.

The material of the layer is then cured in a location-specific manner by means of the exposure unit 20. This procedure is repeated until the dental restoration 12 is completely produced from a plurality of layers.

In the event that the device 10 has an optional drain port 34 as already described, it may also be necessary for the construction platform 16 to be lockable, i.e., to be specifically prevented from moving. This prevents the build platform 16 from moving when material is drained through the drain port 34.

In the example shown in FIG. 47, as already explained, a total of two materials, i.e., a first material M1 and a second material M2, are arranged in the storage space 26.

These materials M1 and M2 differ in terms of at least one material characteristic that describes an optical material property, in particular a material color and/or translucency, a mechanical material property, and/or a chemical material property.

In this context, material M1 may, for example, be designed to replicate a tooth incisal edge, i.e., at least one material characteristic describing an optical material property, in particular a material color and/or translucency, a mechanical material property and/or a chemical material property, is selected such that a tooth incisal edge can be replicated. The material M2 can then be designed to replicate a tooth body, i.e., a tooth crown without the incisal edge. This means that at least one material characteristic describing an optical material property, in particular a material color and/or translucency, a mechanical material property and/or a chemical material property, is selected such that a tooth body can be replicated.

The fill levels of materials M1 and M2 in sections 26a and 26b of the receiving space 26 can be selected so that there is a sufficient quantity of each of the materials M1 and M2 to produce a dental restoration 12. In this case, the usual ratios of the required volumes of materials M1, M2 can be taken into account, e.g., the volume of the material from which the incisal edge of the tooth is relcated may only be approx. 50% of the volume of the material for replicating the tooth body.

The device 10 can, thus, be used to produce the dental restoration 12 layer by layer using the stereolithography process described above. The section of the dental restoration 12 that replicates the incisal edge of the tooth may be produced first by processing the material M1 by actuating the movable wall 30a using the drive 32. Subsequently, the section of the dental restoration 12 that replicates the tooth body can be produced by processing the material M2 by actuating the movable wall 30b by means of the drive 32.

There are two alternatives for driving the movable walls 30a, 30b. In a first alternative, each of the movable walls 30a, 30b can be driven individually. In a second alternative, a single drive is used to drive both walls 30a, 30b. In this case, a piston forming the movable wall 30b may be shorter at an end facing away from the receiving space 26 than a piston forming the movable wall 30a. If, in this case, the drive 32 comprises a drive piston or a pressure plate, the drive 32 will first move the piston with wall 30a and only after some time, when the section of the dental restoration 12 that replicates the incisal edge of the tooth has been produced, will set in motion the piston on which the wall 30b is formed. From this moment onwards, both materials M1 and M2 are processed in mixed form. A mixing chicanery 64 may be provided in the line 24 for this purpose.

The mixing chicanery 64 may have one or more flow obstacles for the materials M1 and M2, so that the flow around the one flow obstacle or the more flow obstacles results in locally different flow velocities of the materials M1 and M2. This leads to mixing of the materials M1 and M2.

In an example in which several flow obstacles are provided, these can be arranged in a regular or irregular grid.

The dental restoration 12 can, thus, be produced, with different sections of the dental restoration 12 being produced from different materials M1, M2 along the construction direction B.

### LIST OF REFERENCE SIGNS

10 Device for additively manufacturing a dental restoration
12 Dental restoration
14 Construction space housing
16 Construction platform
18 Construction space
20 Exposure unit
22 Material storage container
24 Line
26 Receiving space of material storage container
28 Supply port of material storage container
30 Wall
32 Drive
34 Drain port
36 Receiving container
38 Line
40 Receiving space of receiving container
42 Supply port of receiving container
44 Wall of receiving container
46 Drive
48 Trough
50 Mixing device
52 Separator
54 Film
56 Guide element
58 Perforation element
60 Collecting housing
62 Cap
64 mixing chicanery
E Discharge direction
B Construction direction
Q Direction transverse to discharge direction
M1 First material
M2 Second material
M3 Third material
M4 Fourth material
M5 Fifth material
M6 Sixth material

1. Material storage container (22) for material (M1, M2, M3, M4, M5, M6) for additively manufacturing a dental restoration (12), comprising
a receiving space (26) and
a supply port (28) which is coupled to the receiving space (26) in a material-conducting manner, in such a way that the material (M1, M2, M3, M4, M5, M6) can be supplied from the receiving space (26) via the supply port (28) for additively manufacturing the dental restoration (12),
wherein at least a first material (M1) and a second material (M2) which differ in at least one material characteristic, are arranged in the receiving space (26), and
wherein the first material (M1) and the second material (M2) are arranged in succession in a discharge direction (E) of the receiving space (26) and/or
wherein the first material (M1) and the second material (M2) are arranged in succession in a direction (Q) transverse to a discharge direction (E).

2. Material storage container (22) according to claim 1,
wherein the at least one material characteristic describes an optical material property, a mechanical material property or a chemical material property.

3. Material storage container (22) according to claim 1, further comprising
a drain port (34) for removing material (M1, M2, M3, M4, M5, M6) which is not to be used for additively manufacturing a dental restoration (12).

4. Material storage container (22) according to claim 1,
wherein the first material (M1) and the second material (M2) are each arranged in the form of a discrete macroscopic layer, and/or
wherein numerous materials (M1, M2, M3, M4, M5, M6) which differ in at least one material characteristic are arranged in the receiving space (26), the numerous materials (M1, M2, M3, M4, M5, M6) being arranged in succession in the discharge direction (E) of the receiving space (26) or transverse to the discharge direction of the receiving space so as to result in a macroscopically continuous progression of the at least one material characteristic.

5. Material storage container (22) according to claim 1, further comprising
a separating element (52) arranged between the first material (M1) and the second material (M2) so as to separate the first material (M1) from the second material (M2).

6. Material storage container (22) according to claim 5,
wherein the separating element (52) and/or a side wall delimiting the receiving space (26) have a guide element (56) for guiding the separating element (52) in the discharge direction (E).

7. Material storage container (22) according to claim 5,
wherein the separating element (52) comprises a film (54) or a membrane or a fixed wall element.

8. Material storage container (22) according to claim 5, further comprising
a perforation element (58) for breaking open the separating element (52).

9. Method for filling a material storage container (22) for material (M1, M2, M3, M4, M5, M6) for additively manufacturing a dental restoration (12), comprising:
introducing a first material (M1) and a second material (M2) into a receiving space (26) of the material storage container (22),
wherein the first material (M1) and the second material (M2) differ in at least one material characteristic, and
wherein the first material (M1) and the second material (M2) are arranged in succession in a discharge direction (E) of the material storage container (22) and/or
wherein the first material (M1) and the second material (M2) are arranged in succession in a direction (Q) transverse to a discharge direction (E).

10. Method according to claim 9, further comprising:
reducing the viscosity of the first material (M1) and/or the second material (M2) prior to introduction into the receiving space (26).

11. Device (10) for additively manufacturing a dental restoration (12), comprising
a construction space (18) for the additive construction of the dental restoration (12) and
a material storage container (22) according to claim 1 which is coupled to the construction space (18) in a material-conducting manner.

12. Method for additively manufacturing a dental restoration (12), comprising:
creating a first component layer of the dental restoration (12) from a first material (M1) and subsequently creating a second component layer of the dental restoration (12) from a second material (M2), and/or
creating a component layer from the first material (M1) and the second material (M2),
wherein the first material (M1) and the second material (M2) differ in at least one material characteristic and
wherein the first material (M1) and the second material (M2) are supplied by said material storage container (22).

13. Method according to claim 12,
wherein the at least one material characteristic describes an optical material property, a mechanical material property or a chemical material property.

14. Method according to claim 12, further comprising:
draining the first material (M1) and/or the second material (M2) which is not used for manufacturing the dental restoration (12).

15. Material storage container (22) according to claim 2,
wherein the optical material property comprises a material colour and/or a translucency.

16. Device (10) according to claim 11,
wherein the device comprises a drain port (34) for removing material (M1, M2, M3, M4, M5, M6) which is not to be used for additively manufacturing a dental restoration (12).

17. Method according to claim 13,
wherein the optical material property comprises a material colour and/or a translucency.
